(19) United States
(12) Patent Application Publication
(10) Pub. No.: US 2010/0326605 A1
(43) Pub. Date: Dec. 30, 2010

(54) END CAP FOR BLIND WITH ENTRY GUIDE

(76) Inventor: Francisco Guillen Chico, Alicante (ES)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/866,916

(22) PCT Filed: Feb. 15, 2008
(86) PCT No.: PCT/ES08/70024

§ 371 Date: Sep. 10, 2010

(30) Foreign Application Priority Data
Feb. 11, 2008 (ES) P200800360

(51) Int. Cl. E06B 9/38

(52) U.S. Cl. 160/181

(57) ABSTRACT

The present invention refers to an end cap with entry guide of the type used as lateral cover for a blind housing. The end caps consist of a base which has an outlet point corresponding to the lateral vertical profiles which serve as a guide for the slats of the blind as it ascends and descends. The entry guides consist of elements situated in the end caps and adjacent to their outlet point, the function of which is to ensure that the slats attack the outlet point of the end cap at an angle which facilitates operation of the blind. The end cap is characterised in that the entry guide is provided with means for adjusting its position so that it varies the distance between it and the mouth of the outlet point. In this way it is possible to use the same end cap for different types and sizes of slats and blinds.

### OBJECT OF THE INVENTION

The present invention refers to an end cap with entry guide of the type used as lateral cover for a blind housing. The end cap consists of a base which has an outlet point corresponding to the lateral vertical profiles which serve as a guide for the slats of the blind as it ascends and descends. The entry guides are elements situated on the end caps and adjacent to the outlet point of the end cap itself, which serve to ensure that the slats attack the outlet point of the end cap at an angle which aids smooth operation, without any locking during the rolling and unrolling of the blind.

The end cap which is the object of the invention is characterised in that the entry guide is provided with means for adjusting its position so that it varies the distance between it and the mouth of the outlet point. In this way it is possible to use the same end cap for different types and sizes of slats and blinds.

### BACKGROUND TO THE INVENTION

End caps for blinds consist of a part or a set of parts situated at the end of the housing which holds the rolled blind in its upper part.

The end cap is provided with a cavity, to which various accessories are attached, for the correct rolling of the blind slats and they usually have a cover which serves as an adornment, as well as closing the arrangement and preventing lateral displacement of the slats.

The end caps may be provided with an extension which corresponds to the outlet point of the end cap which may form part thereof, or which may be an independent part through which the slats access and leave the end cap during the rolling and unrolling of the blind. This extension links up to the lateral vertical guides of the blind.

For the transition of the slats from the rolled position to the extension zone, intermediate elements known as entry guides are used which ensure that the slats attack the extension outlet by means of an adequate angle for the correct operation of the blind. An adequate range of angles determines the correct operation of the blind and varies on the basis of the type of slat and their dimensions.

At present, entry guides consist of intermediate parts which are generally rounded in shape and which determine a path with a converging form towards the outlet of the extension, thus adequately guiding the slats towards it.

These entry guides are designed for end caps of varying dimensions with a narrow range of values which are not useable in end caps with a differing span. The use of this type of part requires a family of sizes to be made available, which imposes the need to manufacture a mould for each size. This invention aims to resolve the problem by including in a single design a sole entry guide, which is valid and operative for end caps of all sizes.

### DESCRIPTION OF THE INVENTION

This invention refers to an end cap with entry guide for blinds which resolves the technical problem raised by means of a entry guide, which may be used with end caps of varying dimensions, thus achieving optimum operation of the blind. The end caps are provided with a lateral cover which serves to decorate the housing of the blind.

The end cap which is the object of this invention is characterised in that it includes means for adjusting its position so that it is possible to vary the distance between the entry guide and the outlet opening, thus enabling the entry guide to be used with various end caps, slats and guides.

Secondarily, the entry guide comprises a rotating element which is able to turn in respect of an axis essentially perpendicular to the base of the end cap and adjacent to the opening of the outlet. In this way the slats are able to slide on the rotating element attacking the outlet at the adequate angle and thus facilitating a smoother operation, without any locking in the rolling and unrolling of the blind.

### DESCRIPTION OF THE DRAWINGS

The present descriptive report is complemented by a set of plans illustrating a preferred embodiment of the invention, but which is in no way restrictive.

FIG. 1 shows a perspective view of an example of an embodiment of an end cap.

FIG. 2 is a perspective view of the end cap corresponding to FIG. 1 in which an embodiment of the entry guide which is the object of this invention is integrated.

FIG. 3 shows a perspective view of the end cap corresponding to FIG. 1, with the entry guide which is the object of the embodiment of FIG. 2, in which the components are shown in mounted position.

### PREFERRED EMBODIMENT OF THE INVENTION

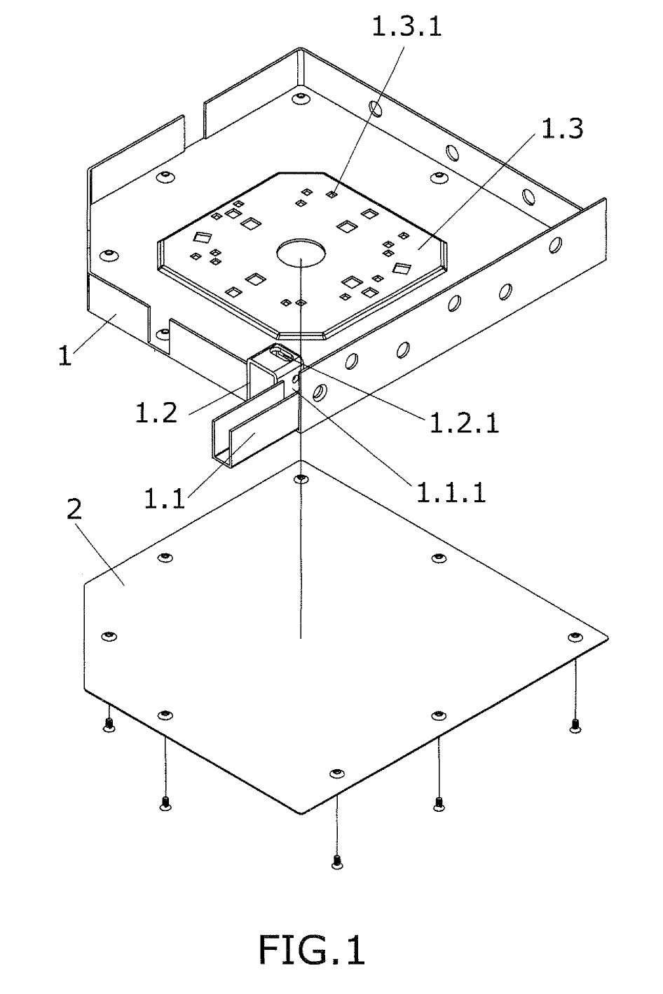

FIG. 1 shows an end cap which comprises a base (1) and a removable decorative cover (2) with both parts (1, 2) joined, in this case by means of screws.

The base (1) comprises an extension (1.1) which corresponds to the outlet point destined to serve as a guide for aligning the slats.

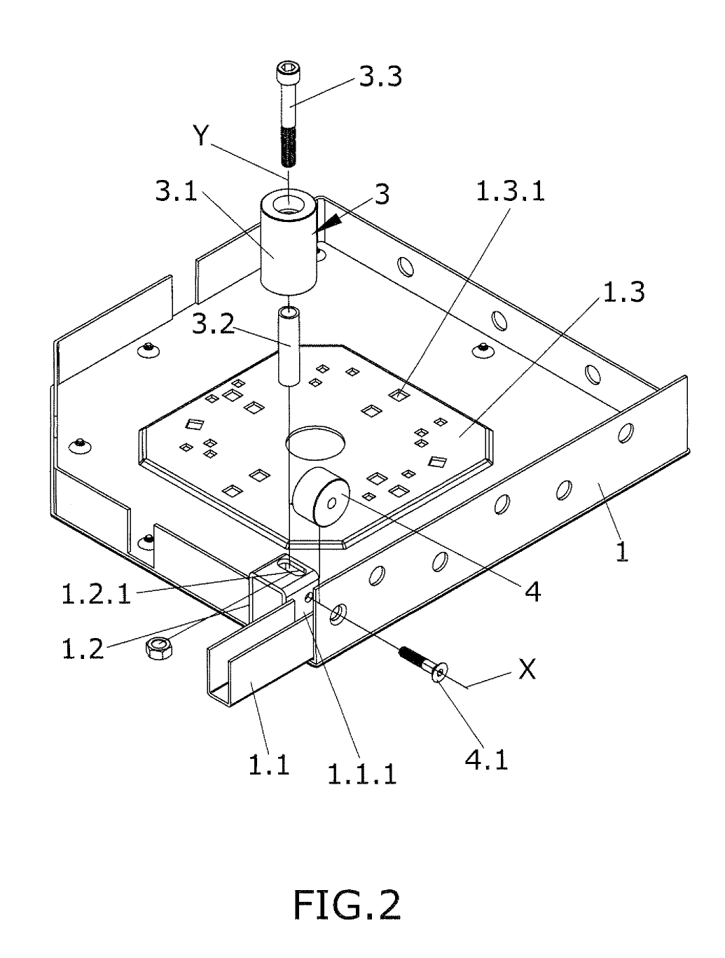

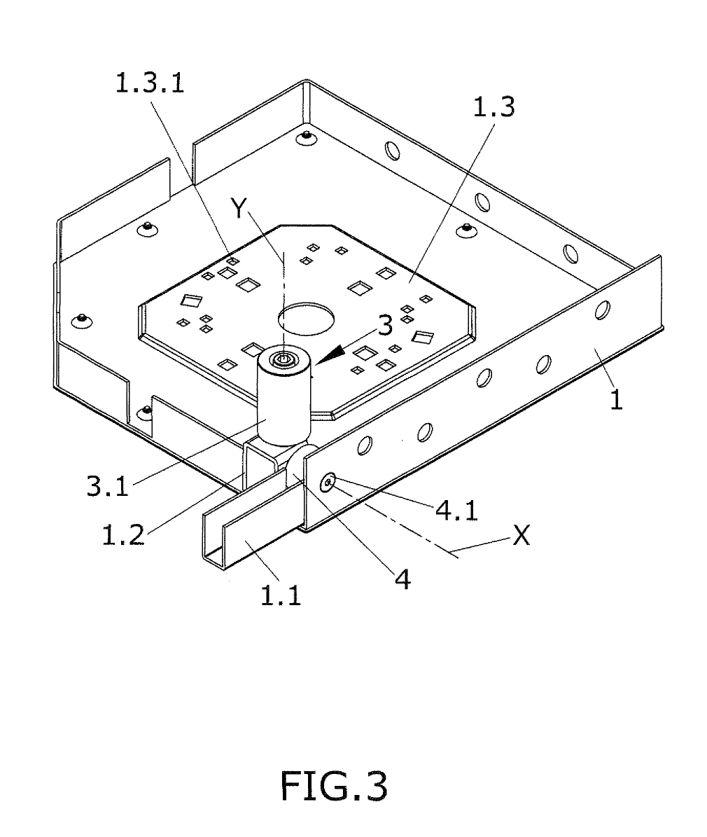

FIG. 2 shows a entry guide (3) which comprises a rotating element (3.1) which is situated on a base (1.2) see FIGS. 2 and 3, with its rotation axis (Y) essentially perpendicular to the plane of the base (1) and attached to the outlet (1.1.1) of the extension (1.1) so that the slats enter into contact therewith (3.1) being driven along their path to the extension (1.1). In this example of an embodiment the rotating element (3.1) is turned by means of the combination of tubular element (3.2)-attachment element (3.3) which configure the physical rotation axis. In the embodiments shown in the figures, the rotating element (3.1) takes the form of a cylinder.

In order for the end cap to be appropriate for various sizes of blinds which are also provided with slats of different types and size, the rotating element (3.1) comprises a means of adjustment of its position which permits variation of the distance between this (3.1) and the outlet (1.1.1) of the extension (1.1). For this purpose in the preferred embodiment, the base (1.2) on which the rotating element (3.1) is located comprises a longitudinal groove (1.2.1) essentially perpendicular to the extension (1.1) which therefore permits the variation in position of the rotating element (3.1) approaching or distancing it from the outlet (1.1.1) of the extension (1.1) based on the type and dimensions of the slat.

Other examples of embodiment of the means for adjusting the position of the rotating element (3.1) are possible; for example, instead of the longitudinal groove (1.2.1) it is possible to provide a plurality of holes corresponding to different predetermined positions of possible connection of the rotating element (3.1) to the base (1), making use of one of these holes for the correct functioning of every possible type and dimension of slat.

Another embodiment for these means of adjusting the position of the rotating element (3.1) may include the use of a spring which consists of means for connection to the rotating element (3.1) so that according to the slat type and dimensions, the elastic force of the spring displaces the rotating element (3.1) varying the distance between this (3.1) and the outlet (1.1.1).

Additionally, the preferred embodiment also includes means which enable the correct alignment of the slats to their entry in the extension (1.1). These means consist traditionally of a type of projection in the base of the extension (1.1) that is, in the direction of the advance of the slats.

In the embodiments of an example of the invention shown in the figures, these means for the correct alignment of the slats comprise a second rotating element (4). This second rotating element (4) facing the outlet (1.1.1) of the extension (1.1) has its rotation axis (X) essentially perpendicular to the direction of advance of the slats in the outlet point, that is, to the extension (1.1) in such a way that the slats would pass over it (4) in the blind rolling and unrolling procedure. The rotation is achieved by means of a pin element (4.1).

In addition, the end cap shown in the preferred embodiment includes in its central zone (1.3) cavities (1.3.1) with different forms and dimensions and in different locations permitting the attachment of the adequate accessories such as bearings and drive motors for blinds of different sizes, configuring in this way a universal end cap suitable for different types and sizes of blind.

The central zone (1.3) is provided with a hollow for housing the anchoring screw heads of the accessories which would be concealed by the cover (2).

What is claimed is:

1. End cap with entry guide for a blind, with the end cap comprising a base (1) and an outlet point in correspondence with vertical lateral profiles which serve as a guide for the slats of the blind as it rises and descends and with the entry guide (3) situated adjacent to the mouth (1.1.1) of the outlet point characterised in that the entry guide (3) comprises means for adjusting its position for varying the distance between the guide (3) and the opening (1.1.1) of the outlet point.

2. End cap with entry guide for blind, according to claim 1, characterised in that the means for adjusting the position of the entry guide (3) include a longitudinal groove (1.2.1) in the connection of the guide (3) to the base (1) which permits attachment along its length.

3. End cap with entry guide for blind, according to claim 1, characterised in that the means for adjusting the position of the entry guide (3) include a plurality of holes corresponding to the various possible predetermined positions for connection of the rotating element (3.1) to the base (1) making use of one of these holes depending on the possible type and dimension of the slat.

4. End cap with entry guide for blind, according to claim 1, characterised in that the means for adjusting the position of the entry guide include the use of a spring which consists of means for connection to the rotating element (3.1) so that according to the slat type and dimensions, the elastic force of the spring displaces the rotating element (3.1) varying the distance between this element (3.1) and the mouth (1.1.1).

5. End cap with entry guide for blind, according to claim 1, characterised in that the entry guide (3) includes a rotating element (3.1) with the ability to rotate in respect of an axis (Y) essentially perpendicular to the base (1) of the end cap, and adjacent to the mouth (111) of the outlet point.

6. End cap with entry guide for a blind, according to claim 5 characterised in that the rotating element (3.1) consists of a cylinder.

7. End cap with entry guide for blind, according to claim 6, characterised in that the rotating element (3.1) is situated on a base (1.2) adjacent to the mouth (1.1.1) of the outlet point.

8. End cap for blind, according to claim 1, characterised in that the entry guide (3) additionally includes a second rotating element (4) of an axis which is essentially perpendicular to the direction of advance of the slats in the outlet point and situated in its mouth (1.1.1) which facilitates correct alignment of the slats.

9. End cap with entry guide for blind, according to claim 1, characterised in that the end cap is provided with cavities (1.3.1) in its central zone (1.3) with different forms and dimensions and different locations, which enables the attachment of accessories suitable for blinds of different dimensions and slats.

10. End cap with entry guide for a blind, according to claim 9, characterised in that the central zone (1.3) is provided with a hollow for housing the screw heads anchoring the accessories.

11. End cap with entry guide for a blind, according to claim 1 characterised in that the outlet point includes an extension (1.1).

12. End cap with entry guide for a blind, according to claim 1, characterised in that it includes a removable cover (2).
